(19) United States
(12) Patent Application Publication
(10) Pub. No.: US 2002/0016831 A1
(43) Pub. Date: Feb. 7, 2002

(54) Apparatus and method for locating of an internet user

(75) Inventors: Ariel Peled, Even-Yehuda (IL); Arik Baratz, Hadera (IL); Ofir Carny, Kochav-Yair, IL (US)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Vidius Inc.

(21) Appl. No.: 09/922,846

(22) Filed: Aug. 7, 2001

Related U.S. Application Data
(60) Provisional application No. 60/223,432, filed on Aug. 7, 2000.

(51) Int. Cl. G06F 15/16; H04L 9/32; G06F 12/14

(52) U.S. Cl. 709/219; 705/27; 713/201

(57) ABSTRACT

A system for locating an online digital content user's geographical and/or virtual location is presented. In one embodiment of the present invention, Geolocation is performed by extracting the user's ISP's DNS IP address. The extracted information may thereafter be correlated with existing data so as to determine and authenticate the user's identity, and/or other properties. The system may also be used to enable electronic commerce bodies such as digital media distributors operating on the Internet to better manage network resources and/or to prevent possible implications of erroneous or fraudulent transaction of digital goods and/or to comply with business rules.

### RELATIONSHIP TO EXISTING APPLICATIONS

The present application claims priority from U.S. Provisional Application No. 60/223,432 filed Aug. 7, 2000.

### FIELD OF THE INVENTION

The present invention relates to the field of location filtering including geo-filtering. More specifically but not exclusively, the present invention relates to methods in which an online distributing entity such as an online shop and/or digital media content distributor can locate, identify and authenticate the regional location of a user, both in geographical and in network topology terms.

### BACKGROUND OF THE INVENTION

Online distribution entities, including digital commercial entities such as online shops, media distributors and/or digital content providers, operate in a global environment that extends very easily to a variety of geographical locations. Connections via the Internet or any other global electronic network, may thus be assisted by the availability of authentic data concerning the identity of the potential user and/or consumer requesting electronic goods.

Authenticating a potential or existing user/consumer's identity is a primary need for online vendors such as electronic stores or distributors of digital content. Such authentication may be necessary in order to prevent fraud or simply desirable in order to enrich the site's accumulated database regarding a specific user and/or user group.

Furthermore, digital media distributors often face situations where distribution of digital media tides to users situated in different geographical zones may bear different implications. Such differences can be attributed to a number of sources as follows:

The legal regime—this includes differing regulations such as differences in the copyright protection situation—an item may for example be protected in one jurisdiction and not protected in another, or differences in content rating regimes a situation in which an item permitted in one country is altogether banned in another. A further example concerns online gambling, which is treated differently under different jurisdictions,

Linguistic differences—such differences may result in different requirements for subtitles, or require the supplier to provide a specific language version,

Electronic format differences—a difference in broadcast formats or encoding schemes etc,

Furthermore, some business models involve the personalization of content in a manner such tat a specific user receives only relevant content according to his or her requirements, location being one of the conditions that the personalization is meant to satisfy.

In addition, the ability to geo-locate a potential consumer/user allows an electronic commerce vendor and/or digital media distributor to better manage a differential distribution policy that aligns with their business and/or marketing strategy. A distributor may for example have separate distribution agreements for different regions, in which case misdirected digital media content and/or electronic goods may cause a violation of the distributor's commercial agreements with local vendors, or the distributor may be part of an agreement in which profits from a certain geographical location have to be shared with a local vendor. Such an arrangement is common for example in cases where a local vendor takes responsibility for advertising within his designated domain.

Another aspect of geo-locating of a user concerns virtual network topology. Distributors of digital media content responding to a user and/or subscriber's order, seek the most efficient way to reach the consumer, trying to avoid as many waypoints or network nodes as possible. Minimization of network nodes is desirable as costs may be related to transmitting data through mediators such as ISP's. That is to say the ISP's may debit the distributor, so that connecting to a user through several ISPs in order to download media content may render the transaction uneconomical for the distributor. Such is particularly the case with distributors of video-on-demand type content, which is very data intensive. It is in the distributors interest therefore, to identify the user's network location in advance.

Previous attempts to address the need for geolocation give partial solutions to the problem: U.S. Pat. No. 6,108,703 describes a network architecture or framework that supports hosting and content distribution on a global scale. The framework allows a content provider to replicate and serve its most popular content from an unlimited number of points throughout the world. The framework comprises a set of servers operating in a distributed manner. The actual content to be served is preferably supported on a set of host servers, sometimes referred to as ghost servers. The content may typically comprise HTML page objects that, conventionally, are served from a Content Provider site. In accordance with the invention, however, a basic HTML document portion of a Web page is served from the Content Provider's site while one or more embedded objects for the page are served from the hosting servers, preferably those of the hosting servers that are near to the client machine. By serving the basic HTML document from the Content Provider's site, the Content Provider maintains control over the content.

The citation, however, relates to only one facet of the problem, namely to the allocation of online resources, and does not describe any procedure for extracting geographic information about users.

Other methods for Geo-locating of a user include locating a user by analyzing source IP retrieved from packets at the server side, a method that can lead to errors due to uncertain or otherwise ambiguous network topologies.

Another mode of operation consists on having the information willingly disclosed by the user, a method that is highly insecure and relies solely on the user's integrity.

Other known methods of retrieving a user's geographical location may conflict with user privacy concerns.

A method in which the true regional location of a potential consumer and/or user can be extracted may be very useful for electronic commerce as a whole. Demand for such a method encompasses not only online stores but also applies to video-on-demand vending and the distribution of content by cable or satellite.

The apparatus and methods disclosed herein may solve the drawbacks of the above-mentioned prior art by suggesting innovative, more robust (in terms of identifying an accurate location) methods of geo-location of the on-line user.

### SUMMARY OP THE INVENTION

Embodiments of the present invention provide apparatus and methods for extracting the geographical and/or virtual location of an Internet user, requesting for example goods or services or other interactions.

A preferred embodiment of the present invention is based on locating the DNS identification of the ISP through which the user is connected.

The apparatus and method may provide online entities with a tool to prevent fraud, or to avoid or manage the implications of wrongly directed goods. More generally it may provide an aid for business management and likewise may serve as a tool for network resource management.

According to a first aspect of the present invention there is provided apparatus for determining a location of a user client in an electronic interaction with a server over a network having a plurality of nodes at different locations, the apparatus comprising:

a network node data gatherer for obtaining from the vicinity of said user client network node information, and

a network node data correlator for correlating said network node information with a network node location map, thereby to provide said server with a location for said user client.

In a preferred embodiment, the apparatus further comprises a digital media distributor associated with said network data correlator and operable to use said location to govern digital media distribution to said user client.

In a preferred embodiment, the apparatus further comprises a location configuration unit for separately determining that said location provided by said client network node information is part of a current communication pat to said user client.

Preferably, said network node location map is a map of said network and said client network node information is an identification of an Internet gateway used by said user client.

Preferably, said identification of said Internet gateway is an IP address of said gateway.

Preferably, said network node data gatherer comprises a request inducer unit for causing said user client to request a connectible entity from the server, and wherein said network node data gatherer is operable to intercept network node data from said Internet gateway following said request.

Preferably, said connectible entity is a loadable entity.

Preferably, said loadable entity is web browser loadable entity.

In a preferred embodiment, lie apparatus further comprises a host name assigner for assigning a host name to said connectible entity for each user client request, thereby to cause said Internet gateway to reveal its identity whilst attempting to locate said hostname.

Preferably, said host name is a unique host name for each user client request.

In a preferred embodiment, the apparatus further comprises a master DNS, said master DNS being operable to give out to said user client an IP address upon requesting by said user client.

In a preferred embodiment, the apparatus further comprises at least one secondary DNS.

Preferably, said connectible entity is assignable a unique host name for each transaction request.

Preferably, said loadable entity is a web page.

Additionally or alternatively, said loadable entity is a web page component.

Additionally or alternatively, said loadable entity is an image.

Additionally or alternatively, said loadable entity is a loadable executable module.

Preferably, said correlator is operable to correlate a received ISP DNS with a user client request using said host name.

Preferably, said map comprises physical location data of network nodes.

Additionally or alternatively, said map comprises topological location data of network nodes.

In a preferred embodiment, the apparatus further comprises a service level controller for selecting service criteria to be provided to said user client based on said physical location.

A preferred embodiment is operable to log a physical location related to a sale.

A preferred embodiment is operable to associate alarms with predetermined physical locations.

A preferred embodiment is arranged to access a geographically arranged database, thereby to associate service criteria with predetermined physical locations.

A preferred embodiment is arranged to access a geographically arranged database, thereby to associate alarms and service criteria with predetermined physical locations.

Preferably, said service criteria comprise criteria to conform with location-based legal restrictions.

Preferably, said service criteria comprise criteria to conform to location-based contractual restrictions, Preferably, said service criteria comprise criteria to conform to location-based commercial restrictions.

In a preferred embodiment, the apparatus further comprises a service level controller for selecting service criteria to be provided to said user client based on said topological location.

In a preferred embodiment, the apparatus further comprises a routing controller for controlling routing to said user client based on said topological location.

In a preferred embodiment, the apparatus further comprises a request for a user telephone number, said apparatus being operable to confirm contact via said telephone number by giving a user a identification for looping using said user client and a connection made using said telephone number.

Preferably, said map comprises a physical map of said telephone network, usable to correlate a physical location to a telephone number.

Preferably, the network node data gatherer comprises a request for the user to contact a telephone number, said apparatus being operable to confirm contact via said telephone number by giving a user an identification for looping back to said apparatus using said user client and a connection made using said telephone number.

Preferably, said map is a physical map of said telephone network, usable to correlate a physical location to a telephone number.

In a preferred embodiment, the apparatus further comprises an authentication unit operable to obtain a modem telephone number of said user client, thereby to attempt to establish contact with said user client.

In a preferred embodiment, the apparatus further comprises an authentication unit contactable by the modem of said user client, thereby to attempt to establish contact with said user client.

In a preferred embodiment, the apparatus further comprises an authentication unit operable to obtain a modem telephone number of said user client and to determine tat contact is established with said user client using said given modem number.

Preferably, said authentication unit is operable to send authentication information via said connection for return via said network connection.

Preferably, said authentication unit is operable to send authentication information via said connection for return via said network correction, Additionally or alternatively, the authentication unit is operable to send authentication via said network for return via said direct connection Additionally or alternatively, said authentication unit is operable to send authentication via said network for return via said direct connection.

In a preferred embodiment, the apparatus further comprises:

trace routing functionality for determining a network node distance and route of a user client by sending and attempting to receive response messages having varied time to live values,

In a preferred embodiment, the apparatus further comprises combining trace routing from several locations to the user in order to enhance accuracy and gather more information.

In a preferred embodiment, the apparatus further comprises a correlator for correlating between said determined location and said determined network node distance and route.

Preferably, said network node data gatherer comprises a connectible entity for carry out trace routing to said server from said user client and sending results of said trace routing to said server.

Preferably, said network node data gatherer comprises a software agent locatable at a network access node.

Preferably, said network access node is a digital network access node.

Preferably, the digital network access node is a digital line access multiplexer.

Preferably, said network node is an internet service provider comprising a plurality of servers and said network node data gatherer comprising functionality to determine additional information of said user client from an individual one of said plurality of servers with which it connects.

Preferably, said network node data gatherer is operable to obtain said additional information by correlating with a user database of the Internet service provider.

In a preferred embodiment, the apparatus further comprises a database builder for building a database of user clients to correlate obtained location data with other data concerning said user clients.

In a preferred embodiment, the apparatus further comprises a line measuring unit for measuring connection line qualities, thereby to obtain said location information.

In a preferred embodiment, the line measuring unit further comprises a connection comparison gait for comparing line qualities of different connections.

Preferably, the qualities include; signal to noise ratio, specific frequency attenuation, end path delay, echo characteristics, delay variance, and compression artifacts.

According to a second aspect of the present invention there is provided a method for determining a location of a user client in an electronic interaction with a server over a network having a plurality of nodes at different locations, the method comprising:

obtaining, from the vicinity of said user client network node information, and

correlating said network node information with a network node location map, thereby to provide said server with a location for said user client.

Preferably, the method further comprises separately determining that said location provided by said client network node information is part of a current communication path to said user client.

Preferably, said client network node information is an identification of an Internet gateway used by said user client.

Preferably, said identification of said Internet gateway is a DNS of said gateway.

Preferably, the method further comprises

causing said user client to request a connectible entity from the server, and

intercepting network node data from said Internet gateway following said request.

Preferably, the method further comprises assigning a host name to said connectible entity for each user client request, thereby to cause said Internet gateway to attempt to locate said hostname and reveal its identity in the course thereof.

Preferably, said assigning a host name comprises assigning a unique host name.

Preferably, said method comprises said master DNS giving to said user client an IP address upon requesting by said user client.

Preferably, said server further comprises at least one secondary DNS being operable to provide IP addresses to said user client.

Preferably, the method further comprises assigning to said connectible entity a host name for each transaction request.

Preferably, the method further comprises providing a unique host name for each user client for each session.

Preferably, said loadable entity is a web page.

Additionally or alternatively, said loadable entity is an image.

Additionally or alternatively, said loadable entity is a loadable executable module.

Additionally or alternatively, said loadable entity is a web component, Preferably, the method further comprises correlating a received ISP DNS with a user client request using said host name.

Preferably, said map comprises physical location data of network nodes.

Additionally or alternatively, said map comprises topological location data of network nodes.

Preferably, the method further comprises selecting service criteria to be provided to said user client based on said physical location.

Preferably, the method further comprises logging a physical location related to a sale.

Preferably, the method further comprises associating alarms with predetermined physical locations.

Preferably, said service criteria comprise criteria to conform with location-based legal restrictions.

Preferably, the method further comprises selecting service criteria to be provided to said user client based on said topological location.

Preferably, the method further comprises controlling routing to said user client based on said topological location.

Preferably, the method further comprises making a request for a user telephone number, said method being operable to make contact using said telephone number to give a user a identification for returning via said user client, said map being a physical map usable to correlate a physical location to a telephone number.

Preferably, the method further comprises making a request for a user telephone number, said method being operable to verify contact via said telephone number by giving a user a identification via said network for returning via a direct connection using said telephone number, said map being a physical map usable to correlate a physical location to a telephone number.

Preferably, the method further comprises the step of obtaining a modem telephone number of said user client, thereby to attempt to establish contact with said user client.

Preferably, the method further comprises requesting the user to contact a telephone number, thereby to confirm contact via said telephone number by giving a user an identification for looping back using said user client and a connection made using said telephone number.

Preferably, the method further comprises an authentication stage of receiving a connection from the modem of said user client, thereby to attempt to establish contact with said user client.

Preferably, the method further comprises sending authentication information via said connection for return via said network connection.

Preferably, the method further comprises sending authentication via said network for return via said direct connection.

Preferably, the method further comprises:

trace routing functionality for determining a network node distance and route of a user client by sending and attempting to receive response messages having varied time to live values,

and correlating between said determined location and said determined network node distance.

Preferably, the method further comprises sending a loadable entity to said receiving client for carrying out trace routing to said server from said user client and sending results of said trace routing to said server.

Preferably, the method further comprises locating a software agent at a network access node to gather data of a receiving client connecting via said node.

Preferably, said network access node is a digital network access node.

Preferably, the digital network access node is a digital line access multiplexer.

Preferably, said network node is an internet service provider comprising a plurality of servers, the method further comprising determining additional information of said user client from an individual one of said plurality of servers with which it connects.

Preferably, the method further comprises obtaining said additional information by correlating with a user database of the Internet service provider.

Preferably, the method further comprises building a database of user clients to correlate obtained location data with other data concerning said user clients.

Preferably, said network node information is obtained in response to an interaction request from said user client and comprising a step of correlating said network node information with said interaction request by sending said user client a hostname to use in a data request with said network node information.

According to a third aspect of the present invention there is provided apparatus for determining a location of a user client in an electronic interaction with a server over a network having a plurality of nodes at different locations, the apparatus comprising:

a network node data gatherer for obtaining from the vicinity of said user client network node information, and

a network node data correlator for correlating said network node information with a network node location map, thereby to provide said server with a location for said user client,

and wherein said network node location map is a nap of said network and said client network node information is an identification of an Internet gateway used by said user client.

In a preferred embodiment, the apparatus further comprises a digital media distributor associated with said network data correlator and operable to use said location to govern digital media distribution to said user client.

In a preferred embodiment, the apparatus finer comprises a location confirmation unit for separately determining that said location provided by said client network node information is part of a current communication path to said user client.

Preferably, said identification of said Internet gateway is an IP address of said gateway.

Preferably, said network node data gatherer comprises a request inducer unit for causing said user client to request a connectible entity from the server, and wherein said network node data gatherer is operable to intercept network node data from said Internet gateway following said request.

Preferably, said loadable entity is a browser loadable entity.

In a preferred embodiment, the apparatus further comprises a host name assigner for assigning a host name to said connectible entity for each user client request, thereby to cause said Internet gateway to reveal its identity whilst attempting to locate said hostname.

Preferably, said host name is a unique host name for each user client request.

In a preferred embodiment the apparatus further comprises a master DNS, which gives out to said user client an IP address upon requesting by said user client.

In a preferred embodiment, the apparatus further comprises at least one secondary DNS.

Preferably, said connectible entity is assignable a unique host name for each transaction request.

Preferably, said loadable entity is a web page.

Additionally or alternatively, said loadable entity is a web page component.

Additionally or alternatively, said loadable entity is an image.

Additionally or alternatively, said connectible entity is a loadable executable entity.

Additionally or alternatively, said loadable entity is a loadable executable module.

Preferably, said correlator is operable to correlate a received ISP DNS with a user client request using said host name.

Preferably, said map comprises physical location data of network nodes.

Preferably, said map comprises topological location data of network nodes.

In a preferred embodiment, the apparatus further comprises a service level controller for selecting service criteria to be provided to said user client based on said physical location.

The apparatus is preferably operable to log a physical location related to a sale.

A preferred embodiment is operable to associate alarms with predetermined physical locations.

A preferred embodiment is arranged to access a geographically arranged database, thereby to associate service criteria with predetermined physical locations.

A preferred embodiment is arranged to access a geographically arranged database, thereby to associate alarms and service criteria with predetermined physical locations.

Preferably, said service criteria comprise criteria to conform with location-based legal restrictions.

Additionally or alternatively, said service criteria comprise criteria to conform to location-based contractual restrictions.

Additionally or alternatively, said service criteria comprise criteria to conform to location-based commercial restrictions.

In a preferred embodiment, the apparatus further comprises a service level controller for selecting service criteria to be provided to said user client based on said topological location.

In a preferred embodiment, the apparatus further comprises a routing controller for controlling routing to said user client based on said topological location.

According to a third aspect of the present invention there is provided apparatus for deterring a location of a user client in an electronic interaction with a server over a network having a plurality of nodes at different locations, the apparatus comprising:

a network node data gatherer comprising a request for a user telephone number,

a network node data correlator for correlating said user telephone number with a physical map of said telephone network, said map being usable to correlate a physical location to a telephone number network node location map, thereby to provide said server with a location for said user client, and

a digital media distributor associated with said network data correlator and operable to use said location to govern digital media distribution to said user client said apparatus further comprising an authentication unit being operable to confirm contact via said telephone number by giving a user an identification for looping around said network and said user client and a connection made using said telephone number.

Preferably, said authentication unit is operable to obtain a modem telephone number of said user client, thereby to attempt to establish contact with said user client.

Preferably, said authentication unit is operable to obtain a modem telephone number of said user client and to determine that contact is established with said user client using said given modem number.

Preferably, said authentication unit sends authentication information via said direct connection for return via said network connection.

Additionally or alternatively, said authentication unit sends authentication via said network for return via said direct connection.

In a preferred embodiment the apparatus further comprises a line measuring unit for measuring connection line qualities, thereby to obtain confirmation of said location.

Preferably, said fine measuring unit comprises a connection comparison unit for comparing line qualities of different connections.

Preferably, said qualities include any ones of a group comprising: signal to noise ratio, specific frequency attenuation, end path delay, echo characteristics, delay variance, and compression artifacts.

In a preferred embodiment, the apparatus further comprises an interface for interfacing to a telephone number resolving system, thereby to obtain service level conditions associated with particular telephone numbers.

Preferably, said network node data gatherer comprises a request for the user to contact a telephone number, said apparatus being operable to confirm contact via said telephone number by giving a user an identification for looping back to said apparatus using said user client and a connection made using said telephone number.

In a preferred embodiment, the apparatus further comprises an authentication unit contactable by the modem of said user client thereby to attempt to establish contact with said user client.

Preferably, said authentication unit sends authentication information via said connection for return via said network connection.

Additionally or alternatively, said authentication unit sends authentication via said network for return via said direct connection.

According to a further aspect of the present invention there is provided apparatus for determining a location of a user client in an electronic interaction with a server over a network having a plurality of nodes at different locations, the apparatus comprising:

network node data gatherer for obtaining from the vicinity of said user client network node information,

a network node data correlator for correlating said network node information with a network node location map, thereby to provide said server with a location for said user client,

trace routing functionality for determining a network node distance and route of a user client by sending and attempting to receive response messages having varied time to live values,

and a second correlator for correlating between said determined location and said determined network node distance.

According to a further aspect of the present invention there is provided apparatus for determining a location of a user client in an electronic interaction with a server over a network having a plurality of nodes at different locations, the apparatus comprising:

a network node data gatherer for obtaining from the vicinity of said user client network node information, and

a network node data correlator for correlating said network node information with a network node location map, thereby to provide said server with a location for said user client,

and wherein said network node data gatherer is a software agent for placing at least one of said plurality of nodes.

Preferably, said network access node comprises a digital network access node.

Preferably, said digital network access node comprises a digital line access multiplexer.

### BRIEF DESCRIPTION OF THE DRAWINGS

For a better understanding of the present invention, and to show how the same may be carried into effect, reference will now be made to the accompanying drawings, in which:

FIG. 1 is a simplified block diagram of apparatus for geo-filtering of user clients using ISP DNS IP address data, according to a first embodiment of the present invention,

FIG. 2 is a simplified block diagram showing apparatus for carrying out a correlation procedure for the embodiment of FIG. 1,

FIG. 3 is a simplified block diagram showing apparatus for geo-filtering using telephone callback according to a second embodiment of the present invention,

FIG. 4 is simplified block diagram showing apparatus for geo-filtering using IP location according to a third embodiment of the present invention, and

FIG. 5 is a simplified block diagram showing apparatus for geo-filtering of users connected to a computer network by a digital subscriber line, according to a fourth embodiment of the present Invention.

### DETAILED DESCRIPTION OF THE PREFERRED EMBODIMENTS

An Internet user approaching an online store or digital media provider generally does so through the DNS (Domain Name Server) of an ISP (Internet service provider). The user may then be provided a specific IP number, provided by the DNS for the specific session only. As the IP number is random and changes, in most cases it cannot be used to identify the user. The DNS, however, does have a fixed IP number, and all such DNS IP addresses are public knowledge. The DNS itself is thereby traceable via its distinct IP address. The method described herein prompts the ISP's DNS to provide its own IP address to the online vendor's site, following a user request to perform an online transaction, or any other interaction as desired. Furthermore, the ISP itself is able to identify any of its users connecting to the Internet by correlation of entry log data from the DNS with the ISP's user database. Such an ability may be useful when further identification of a specific user is needed.

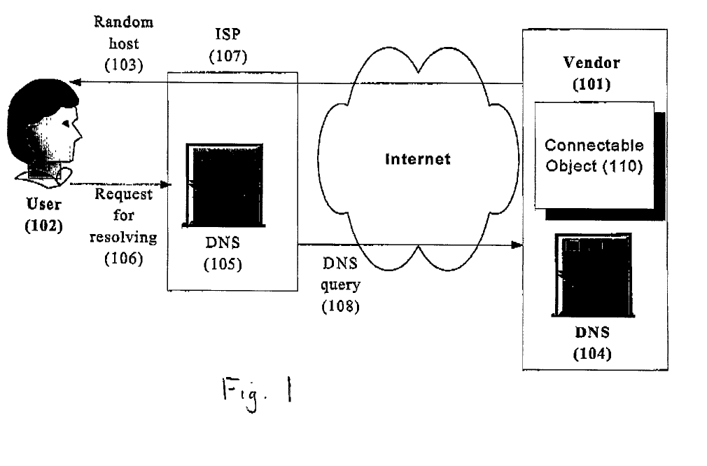

Reference is now made to FIG. 1, which is a simplified diagram of a first embodiment of the present invention. In a session of electronic shopping or similar kind of interaction between an electronic entity or vendor 101 and a user/consumer 102, the user/consumer is redirected by the electronic entity 101 to a page, or to a module thin a page or any element that is loadable or contactable by the consumer, denoted in FIG. 1 as hostname object 110. The element or object preferably contains in its address a host name composed of symbols. The address object preferably conforms to the standards of existing or fixture BIND infrastructure. The user/consumer's browser may be required to load object 110 additionally or alternatively to the above mentioned redirection.

The host to which the user's/consumer is directed may for example be an electronic shop belonging to a commercial domain, or to any other domain, provided that the domain conforms to the BIND specifications. Preferably, the domain has a master DNS 104 and may additionally have one or more secondary DNSs. The host name is preferably but not necessarily unique for each user session and thus new to the user's/consumer's ISP DNS (105). It may, for example, be composed of a random string of symbols, a string representing a serial number or an ordered string, an encoded user ID, a sequential or encoded sequential number, a semi-random number stored in the electronic shop's database or any other option that complies wit BIND specifications.

The redirection preferably serves to direct the consumer's browser to a new page, whether automatically as the user's browser's response to the new page or following a request by the server or as a result of a request 106 by the consumer 102. As is common procedure, the user client may request the actual IP address of the host specified in the new page address from the DNS configured on his system by the ISP 107.

The host name, having been randomly selected, is thus likely to be new to the ISP DNS 103. The ISP DNS 103 is therefore caused to issue a series of queries to other DNS servers in an effort to locate the master DNS for the domain to which the requested host belongs, in a DNS query 108, or alternatively to locate a secondary DNS thereof. When located, the ISP DNS 103 queries the located master or secondary DNS for the address—all according to BIND specifications.

When the master or secondary DNS receives the query, the master or secondary DNS preferably replies to the query with a single IP address, in contrast to the procedure specified by the BIND specifications in which queries for unknown hosts are rejected. The master or secondary DNS may also reply with any IP that the store wishes it to reply with or may refrain from reply altogether. The IP address used in the reply may belong to the operator of the method or to any other entity such as the operator of the method deems appropriate, and the reply containing the IP address preferably looks nice a standard DNS reply for the requested host. The master or secondary DNS preferably notes the IP of the ISP DNS 103, which is included in the request, in its data store or any other storage medium and/or may transmit this information or part thereof to the vendor 101.

The ISP DNS 103 then preferably returns the IP received from the master or secondary DNS to the user, which may then proceed to retrieve the page, or an object therein, according to BIND specifications and in the usual way.

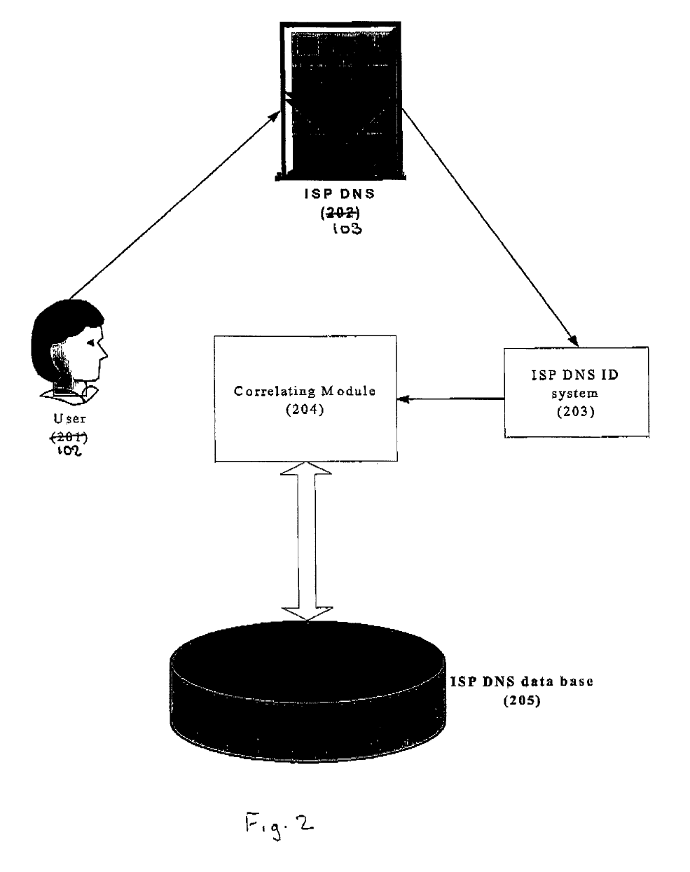

The operator of the method may now compare the IP address of the ISP DNS noted in the data store, with the unique host name provided to the specific user in the specific session with which the request was made, and reference is now made to FIG. 2, which is a simplified diagram showing apparatus, preferably but not necessarily for location at the vendor 101, for carrying out correlations to determine geo-location, that is the physical or topological location of the user client from the received ISP DNS IP address. It will be appreciated that similar correlation apparatus is applicable to the later embodiments. Parts that are the same as those in previous figures are given the same reference numerals and are not described again except as necessary for an understanding of the present embodiment.

An obtained ISP DNS IP address is input to system 203 for analysis. The address is passed to a correlation module 204 where it is correlated firstly with the user client making the request and secondly with a database 205 to give an output of the location (physical or topological) of the ISP, as discussed in more detail below.

The apparatus shown in FIG. 2 preferably enables the operator of the method to correlate the received ISP DNS IP address with a specific user, whether existing in the store's data store or new to the operator of the method. By knowing the ISP DNS IP address the operator of the method may determine the ISP DNS location, as the IP address thereof is a fixed address and corresponding ISP identities are readily obtainable. By correlating the location information with the session 102, the operator is preferably able to determine the user's location at the time of the session.

In a further preferred embodiment of the present invention, a system may correlate the ISP DNS IP address with the user/consumer identity and carry out operations according to the electronic vendor's instructions, such as directing distribution resources, adjusting the content provided to the consumer, adjusting the dialogue with the user/consumer, preventing the transaction altogether etc. Such activities are specifically useful for distributors of video-on-demand and digital content.

A vendor 101 receives an interaction request from a user 102 via the Internet or like electronic connection. The user 102 connects via DNS 103 database and a random host of his internet service provider or ISP 107. The vendor has his own DNS 104. As will be described below, the user 102 is persuaded to give to the vendor 101 the IP address of his ISP 103.

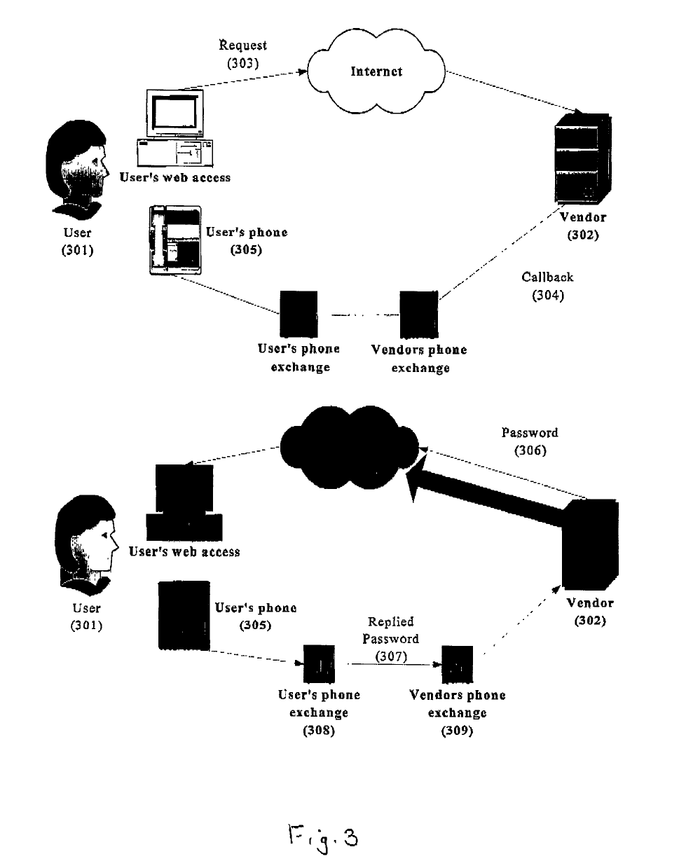

That is to say, to obtain the IP address of ISP 103, as part of the interaction, the user/consumer 102 is preferably directed by the site of the vendor 101 to a page, or to a module within the current page or to any element usable with the consumer's browser, which preferably contains in its address a host name composed from symbols under the constraints of existing or future BIND standard infrastructures. Reference is now made to FIG. 3, which is a simplified block diagram showing a further embodiment of the present invention. In the embodiment of FIG. 3, geo-filtering of clients for a digital multimedia distribution system, such as digital video-on-demand, is performed by the use of a telephone, in a procedure as follows:

As illustrated in FIG. 3, the client/consumer 301 contacts the vendor 302, with a request to purchase 303. The vendor then requests the client's telephone number and calls him back 304 using the supplied telephone number. As the client answers the call, the vendor then provides him/her with a is temporary password 306 and asks him/her to provide a certain signal, e.g., by punching the temporary random password on the telephone using the telephones key-pad 305. The client types the password he is shown 307, and hangs up. The vendor then uses the client's telephone number to identify the client's geo-location from the telephone exchange 308,309, after which the vendor may transfer the content to the client 310.

The method relies on the principle that, much like the broadcast radius of a TV station, a telephone exchange also has a limited geographical range for the customers it serves, and the exchange number is easily derived from a number by taking the first few digits from the number. The method does not apply however, directly to cellular telephones, where the number does not generally indicate a physical locations although it may be used in conjunction with other methods.

In cases such as the aforementioned cellular telephones, but also in AIN applications etc. where the phone number does not in itself reveal the location of the user with the required accuracy or at all, an interface may be set up, either online or offline, to an entity or database holding correlating information for example of suspect mobile telephone numbers whose custom is best avoided.

In addition, advanced methods, for estimating the other party's location by using measurable qualities of the connection, may be used in order to establish or verify the location and/or to increase the precision of the localization. Such qualities may include signal to noise ratio, specific frequency attenuation, end path delay, echo characteristics, delay variance, compression artifacts, and other similar qualities depending on the media involved.

That is to say, quality measurement may be carried out via several such connections, in order to gather more information, and/or in order to discern or verify with greater accuracy, by correlating the information, the approximate location of the other party involved, preferably by correlating information from several sores (e.g., such as connecting the user from multiple phone numbers, or phones which are near the location of the other party).

Additionally, the ‘Caller ID’ attribute may be used, in order to either replace or be added to the above-described method, in order to improve the resolution of the Geo-location. The, method is also applicable to businesses that do not conduct business over the Internet.

In a further embodiment, the user, or the user client's modem, may be prompted to contact a telephone number(,or numbers) or otherwise contact in authenticating entity Of his service provider, in order to perform the aforementioned authentication.

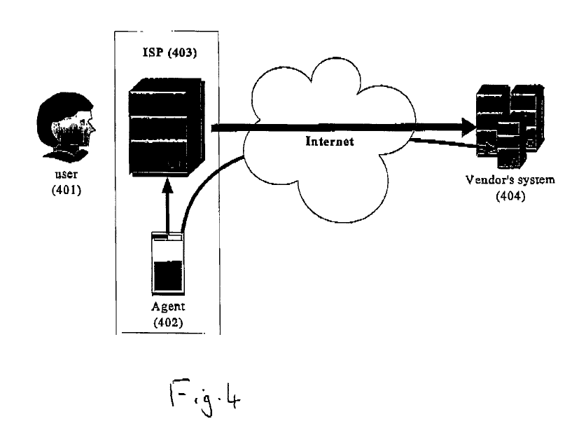

In addition, authentication information, or other information, which is required to be used in the transaction, could be passed in the modem connection. Reference is now made to FIG. 4, which is a simplified diagram showing a further embodiment of the present invention, in which geo-filtering for clients of digital multimedia distribution system, such as digital video-on-demand, is performed by use of an LP (Internet Protocol) location method in a procedure as follows:

A user/client's request 401 for a service, that is to say a request for a transaction or other interaction as discussed above, is sent to die vendor etc. On the way it may be intercepted by a device or agent 402, which may typically be a hardware unit with sniffer-type software or the like, combined with an analysis program, the analysis program being specific to the geolocation purpose. Alternatively, use may be made of a unit provided for other purposes, in which case the sniffer and analysis software may be in the form of a plug-in, or may piggyback ever existing software and/or hardware. In addition, other sniffing methods known to the skilled man may be considered, for example providing a software agent or any similar method, provided that the method involves sniffing functionality tat resides at the client's ISP 403.

The agent may be for example a computer with dedicated software, which identifies the geolocation of the subscriber by associating an IP connection with a particular ISP. The method relies on the property by which ISP users are usually located in the vicinity of the ISP's POP (point of presence), as using an ISP that is geographically close to the customer increases throughput and reduces costs for the user.

The device or agent 402 then communicates with the vendor/policy server 404. As the vendor knows the location of the agent (i.e. its ISP and the geographical position of the point of presence), the vendor can exact the client's location by correlating the data and may handle the request appropriately. It is thus possible to associate a specific customer with a geographical location.

To eliminate the possibility of users being able to give out false IP addresses and/or to verify the information extracted, the agent may send the user or client ping messages each set with a Time To Live (TTL). Successive messages have successively increasing TTLs, preferably increasing by 1 for each occurrence and starting from 1. The sender is able to deduce, from the first ping that returns to him, the number of hops/routers from the agent's location to the client. Such a method is sometimes referred to as Trace Routing and is well-known in the art.

In a further preferred embodiment of the present invention geo-filtering for distribution of digital content is performed by Internet route identification as follows: the consumer/user contacts the vendor regarding content to be delivered to his/her computer, in the usual way. The vendor requires that a small application is loaded and run on the client's computer. The application preferably implements the trace routing algorithm described above, which was originally implemented by Van Jacobson, in order to check the Internet route between the vendor and the user/consumer. After collecting the route information, the application preferably sends that information to the vendor, which, in turn, uses it to identify the Internet service provider (ISP) for the client, hence deducting its location. As it identifies the router closest to the client, the method may also be used to map the network topology within the ISP (with the aid of the ISP).

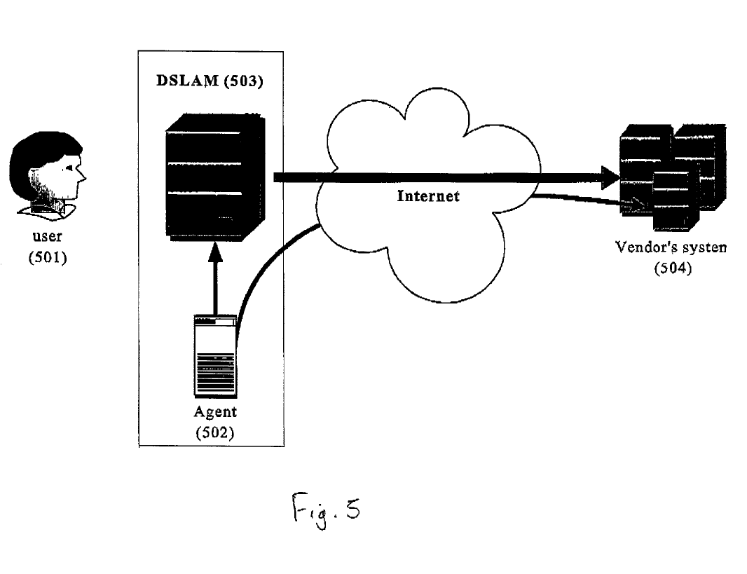

Reference is now made to FIG. 5, which is a simplified diagram showing a further embodiment of the present invention The embodiment of FIG. 5 is particularly useful for geo-location of users 501 that are connected to a computer network, such as the Internet via Digital Subscriber Line (DSL). The method uses a software agent 502 located at a Digital Subscriber Line Access Multiplexer (DSLAM) 503. The software agent can collect information regarding the end-user, such as his or her telephone number and a respective DSL ID number, that may thereafter be used for geo-location and authentication byte vendor's system 504.

In a further embodiment of the present invention, a system making use of information extracted by the system as described above, combined with other sources of information and/or methods of extraction, may determine other properties of the user/consumer and/or may even identify the user/consumer.

In another embodiment, the system may correlate information about the ISP DNS, to determine the user's physical location, by correlating the ISP's identity with information about the location of the particular server of the ISP that the user is using.

In another embodiment of the present invention, the identification features described above may be applied to an entity other than an electronic shop and may be used for purposes other than those of electronic commerce.

Another embodiment of the present invention may be used for building an information base to aid other location methods by correlating the data extracted from it with other known data and or properties of the user/consumer.

In another embodiment the system or method may be applied as an aid in managing and optimizing online distribution resources for online vendors of digital goods, by locating the most efficient route to the user/consumer and/or directing the act of distribution or any other interaction to a server nearer to the consumer/user.

In addition, the system or method may be used by sites and/or vendors to improve interaction with their online users/consumers, whether subscribed or randomly accessing the site/electronic shop.

A further preferred embodiment of the present invention may provide an information source for strategic decision making for one businesses such as the allocation of marketing efforts and resources, mapping the business environment etc.

In addition to applications described above, the system may provide an administrative tool for businesses working under geographically affected legal limitations such as content rating in digital media distribution, copyright issues, and contractual and or commercial limitations due to distribution agreements. All of the above issues may have implications for the distribution efforts of an online vendor. Furthermore, the method or system may be used as an instrument to carry out the vendors and/or user/consumer distribution policy. The method or system may also be applied in the present context to store previously gathered data on ISP DNS IP addresses, so as to alert the vendor if a request originates from a pre-designated area which is of importance to the vendor.

In a further embodiment of the present invention the system or method may provide for a revenue sharing tool between an electronic store/vendor/content site and it's affiliates, by correlating information about the consumer with the areas designated for affiliates, for identification and/or authentication.

It is appreciated that features described only in respect of one or some of the embodiments are applicable to other embodiments and that for reasons of space it is not possible to detail all possible combinations. Nevertheless, the scope of the above description extends to all reasonable combinations of the above described features.

The present invention is not limited by the above-described embodiments, which are given by way of example only. Rather the invention is defined by the appended claims.

1. Apparatus for determining a location of a user client in an electronic interaction with a server over a network having a plurality of nodes at different locations, the apparatus comprising:
a network node data gatherer for obtaining from the vicinity of said user client network node information, and
a network node data correlator for correlating said network node information with a network node location map, thereby to provide said server with a location for said user client.

2. The apparatus of claim 1, further comprising a digital media distributor associated with said network data correlator and operable to use said location to govern digital media distribution to said user client.

3. The apparatus of claim 1, further comprising a location confirmation unit for separately determining that said location provided by said client network node information is part of a current communication path to said user client.

4. Apparatus according to claim 1, wherein said network node location map is a map of said network and said client network node information is an identification of an Internet gateway used by said user client.

5. Apparatus according to claim 4, wherein said identification of said Internet gateway is an IP address of said gateway.

6. Apparatus according to claim 5, wherein said network node data gatherer comprises a request inducer unit for causing said user client to request a connectible entity from the server, and wherein said network node data gatherer is operable to intercept network node data from said Internet gateway following said request.

7. Apparatus according to claim 6, wherein said connectible entity is a loadable entity.

8. Apparatus according to claim 7, wherein said loadable entity is web browser loadable entity.

9. Apparatus according to claim 5, further comprising a host name assigner for assigning a host name to said connectible entity for each user client request, thereby to cause said Internet gateway to reveal its identity whilst attempting to locate said hostname.

10. Apparatus according to claim 9, wherein said host name is a unique host name for each user client request.

11. Apparatus according to claim 9, said server comprising a master DNS, said master DNS being operable to give out to said user client an IP address upon requesting by said user client.

12. Apparatus according to clam 11, said server further comprising at least one secondary DNS.

13. Apparatus according to claim 9, wherein said connectible entity is assignable a unique host name for each transaction request.

14. Apparatus according to claim 6, wherein said loadable entity is a web page.

15. Apparatus according to claim 6, wherein said loadable entity is a web page component.

16. Apparatus according to claim 6, wherein said loadable entity is an image.

17. Apparatus according to claim 6, wherein said loadable entity is a loadable executable module.

18. Apparatus according to claim 13, wherein said correlator is operable to correlate a received ISP DNS wit a user client request using said host name.

19. Apparatus according to claim 1, wherein said map comprises physical location data of network nodes.

20. Apparatus according to claim 1, wherein said map comprises topological location data of network nodes.

21. Apparatus according to claim 19, further comprising a service level controller for selecting service criteria to be provided to said user client based on said physical location.

22. Apparatus according to claim 19, operable to log a physical location related to a sale.

23. Apparatus according to claim 19, operable to associate alarms with predetermined physical locations.

24. Apparatus according to claim 19 arranged to access a geographically arranged database, thereby to associate service criteria with predetermined physical locations.

25. Apparatus according to claim 19, arranged to access a geographically arranged database, thereby to associate alarms and service criteria with predetermined physical locations.

26. Apparatus according to claim 21, wherein said service criteria comprise criteria to conform with location-based legal restrictions.

27. Apparatus according to claim 21, wherein said service criteria comprise criteria to conform to location-based contractual restrictions.

28. Apparatus according to claim 21, wherein said service criteria comprise criteria to conform to location-based commercial restrictions.

29. Apparatus according to claim 20, further comprising a service level controller for selecting service criteria to be provided to said user client based on said topological location.

30. Apparatus according to claim 20, further comprising a routing controller for controlling routing to said user client based on said topological location.

31. Apparatus according to claim 1, said network node data gatherer comprising a request for a user telephone number, said apparatus being operable to confirm contact via said telephone number by giving a user a identification for looping using said user client and a connection made using said telephone number.

32. Apparatus according to claim 31, wherein said map comprises a physical map of said telephone network, usable to correlate a physical location to a telephone number.

33. Apparatus according to claim 1, said network node data gatherer comprising a request for the user to contact a telephone number, said apparatus being operable to confirm contact via said telephone number by giving a user an identification for looping back to said apparatus using said user client and a connection made using said telephone number.

34. Apparatus according to claim 33, wherein said map is a physical map of said telephone network usable to correlate a physical location to a telephone number.

35. Apparatus according to claim 31, further comprising an authentication unit operable to obtain a modem telephone number of said user client, thereby to attempt to establish contact with said user client.

36. Apparatus according to claim 31, further comprising an authentication unit contactable by the modem of said user client, thereby to attempt to establish contact with said user client.

37. Apparatus according to claim 31, further comprising an authentication unit operable to obtain a modem telephone number of said user client and to determine that contact is established with said user client using said given modem number.

38. Apparatus according to claim 37, said authentication unit being operable to send authentication information via said connection for return via said network connection.

39. Apparatus according to claim 36, said authentication unit being operable to send authentication information via said connection for return via said network connection.

40. Apparatus according to claim 37, said authentication unit being operable to send authentication via said network for return via said direct connection.

41. Apparatus according to claim 36, said authentication unit being operable to send authentication via said network for return via said direct connection.

42. Apparatus according to claim 1, further comprising:
trace routing functionality for determining a network node distance and route of a user client by sending and attempting to receive response messages having varied time to live values.

43. Apparatus according to claim 42 further comprising:
combining functionality for combining trace routing from several locations to the user in order to enhance accuracy.

44. Apparatus according to claim 42 further comprising:
a correlator for correlating between said determined location and said determined network node distance and route.

45. Apparatus according to claim 1, wherein said network node data gatherer comprises a connectible entity for carrying out trace routing to said server from said user client and sending results of said trace routing to said server.

46. Apparatus according to claim 1, wherein said network node data gatherer comprises a software agent locatable at a network access node.

47. Apparatus according to claim 46, wherein said network access node is a digital network access node.

48. Apparatus according to claim 46, said digital network access node being a digital line access multiplexer.

49. Apparatus according to claim 1, said network node being an internet service provider comprising a plurality of servers and said network node data gatherer comprising functionality to determine additional information of said user client from an individual one of said plurality of servers wit which it connects.

50. Apparatus according to claim 49, said network node data gatherer being operable to obtain said additional information by correlating with a user database of the Internet service provider.

51. Apparatus according to claim 1, comprising a database builder for building a database of user clients to correlate obtained location data with other data concerning said user clients.

52. Apparatus according to claim 1, further comprising a line measuring unit for measuring connection line qualities, thereby to obtain said location information.

53. Apparatus according to claim 52, said Line measuring unit comprising a connection comparison unit for comparing line qualities of different connections.

54. Apparatus according to claim 52, said qualities being ones of a group comprising: signal to noise ratio, specific frequency attenuation, end path delay, echo characteristics, delay variance, and compression artifacts.

55. Method for determining a location of a user client in an electronic interaction wit a server over a network having a plurality of nodes at different locations, the method comprising:
obtaining, from the vicinity of said user client, network node information, and
correlating said network node information with a network node location map, thereby to provide said server with a location for said user client.

56. The method of claim 55, further comprising separately determining that said location provided by said client network node information is part of a current communication path to said user client.

57. The method of claim 55, wherein said client network node information is an identification of an Internet gateway used by said user client.

58. The method of claim 57, wherein said identification of said Internet gateway is a DNS of said gateway.

59. The method of claim 58, further comprising:
causing said user client to request a connectible entity from the server, and
intercepting network node data from said Internet gateway following said request.

60. The method of claim 59, further comprising assigning a host name to said connectible entity for each user client request, thereby to cause said Internet gateway to attempt to locate said hostname and reveal its identity in the course thereof.

61. The method of claim 59, wherein said assigning a host name comprises assigning a unique host name.

62. The method of cal 60, said server comprising a master DNS, said method comprising said master DNS giving to said user client an IP address upon requesting by said user client.

63. The method of claim 62, said server further comprising at least one secondary DNS being operable to provide IP addresses to said user client.

64. The method of claim 60, comprising assigning to said connectible entity a host name for each transaction request.

65. The method of claim 64, comprising providing a unique host name for each user client for each session.

66. The method of claim 59, wherein said loadable entity is a web page.

67. The method of claim 59, wherein said loadable entity is an image.

68. The method of claim 59, wherein said loadable entity is a loadable executable module.

69. The method of claim 59, wherein said loadable entity is a web component.

70. The method of claim 64, comprising correlating a received ISP DNS with a user client request using said host name.

71. The method of claim 55, wherein said up comprises physical location data of network nodes.

72. The method of claim 55, wherein said map comprises topological location data of network nodes.

73. The method of clam 71, further comprising selecting service criteria to be provided to said user client based on said physical location.

74. The method of claim 71, comprising logging a physical location related to a sale.

75. The method of claim 71, further comprising associating alarms with predetermined physic locations.

76. The method of claim 73, wherein said service criteria comprise criteria to conform with location-based legal restrictions.

77. The method of claim 72, further comprising selecting service criteria to be provided to said user client based on said topological location.

78. The method of claim 72, further comprising controlling routing to said user client based on said topological location.

79. The method of claim 55, comprising making a request for a user telephone number, said method being operable to make contact using said telephone number to give a user a identification for returning via said user client, said map being a physical map usable to correlate a physical location to a telephone number.

80. The method of claim 55, comprising making a request for a user telephone number, said method being operable to vet contact via said telephone number by giving a user a identification via said network for returning via a direct connection using said telephone number, said map being a physical map usable to correlate a physical location to a telephone number.

81. The method of claim 79, further comprising the step of obtaining a modem telephone number of said user client, thereby to attempt to establish contact with said user client.

82. The method of claim 80, further comprising requesting the user to contact a telephone number, thereby to confirm contact via said telephone number by giving a user an identification for looping back using said user client and a connection made using said telephone number.

83. The method of claim 82, further comprising an authentication stage of receiving a connection from the modem of said user client, thereby to attempt to establish contact with said user client.

84. The method of claim 82, further comprising sending authentication information via said connection for return via said network connection.

85. The method of claim 82, comprising sending authentication via said network for return via said direct connection.

86. The method of claim 55, further comprising:
trace routing functionality for determining a network node distance and route of a user client by sending and attempting to receive response messages having varied time to live values,
and correlating between said determined location and said determined network node distance and routing.

87. The method of clam 86, further comprising adding data of further nodes to said correlation to improve accuracy.

88. The method of claim 55, comprising sending a loadable entity to said receiving client for carrying out trace routing to said server from said user client and sending results of said trace routing to said server.

89. The method of claim 55, comprising locating a software agent at a network access node to gather data of a receiving client connecting via said node.

90. The method of claim 89, wherein said network access node is a digital network access node.

91. The method of claim 89, said digital network access node being a digital line access multiplexer.

92. The method of claim 55, said network node being an internet service provider comprising a plurality of servers, the method further comprising determining additional information of said user client from an individual one of said plurality of servers wit which it connects.

93. The method of claim 92, further comprising obtaining said additional information by correlating with a user database of the Internet service provider.

94. The method of claim 55, further comprising building a database of user clients to correlate obtained location data with other data concerning said user clients.

95. The method of claim 55, wherein said network node information is obtained in response to an interaction request from said user client and comprising a step of correlating said network node information with said interaction request by sending said user client a hostname to use in a data request with said network node information.

96. Apparatus for determining a location of a user client in an electronic interaction with a server over a network having a plurality of nodes at different locations, the apparatus comprising:
a network node data gatherer for obtaining from the vicinity of said user client network node information, and
a network node data correlator for correlating said network node information with a network node location map, thereby to provide said server with a location for said user client,
and wherein said network node location map is a map of said network and said client network node information is an identification of an Internet gateway used by said user client.

97. The apparatus of claim 96, further comprising a digital media distributor associated with said network data correlator and operable to use said location to govern digital media distribution to said user client.

98. The apparatus of claim 96, further comprising a location confirmation unit for separately determining that said location provided by said client network node information is part of a current communication path to said user client.

99. Apparatus according to claim 96, wherein said identification of said Internet gateway is an IP address of said gateway.

100. Apparatus according to claim 99, wherein said network node data gatherer comprises a request inducer unit for causing said user client to request a connectible entity from the server, and wherein said network node data gatherer is operable to intercept network node data from said Internet gateway following said request.

101. Apparatus according to claim 100 wherein said loadable entity is a browser loadable entity.

102. Apparatus according to claim 100, further comprising a host name assigner for assigning a host name to said connectible entity for each user client request, thereby to cause said Internet gateway to reveal its identity whilst attempting to locate said hostname.

103. Apparatus according to claim 102, wherein said host name is a unique host name for each user client request.

104. Apparatus according to claim 102, sad serer comprising a master DNS, said master DNS being operable to give out to said user client an IP address upon requesting by said user client.

105. Apparatus according to claim 104, said server further comprising at least one secondary DNS.

106. Apparatus according to claim 102, wherein said connectible entity is assignable a unique host name for each transaction request.

107. Apparatus according to claim 100, wherein said loadable entity is a web page.

108. Apparatus according to claim 100, wherein said loadable entity is a web page component.

109. Apparatus according to claim 100, wherein said loadable entity is an image.

110. Apparatus according to claim 100, wherein said connectible entity is a loadable executable entity.

111. Apparatus according to claim 110, wherein said loadable entity is a loadable executable module.

112. Apparatus according to claim 106, wherein said correlator is operable to correlate a received ISP DNS with a user client request using said host name.

113. Apparatus according to claim 96, wherein said map comprises physical location data of network nodes.

114. Apparatus according to claim 96, wherein said map comprises topological location data of network nodes.

115. Apparatus according to claim 113, further comprising a service level controller for selecting service criteria to be provided to said user client based on said physical location.

116. Apparatus according to claim 113, operable to log a physical location related to a sale.

117. Apparatus according to claim 113, operable to associate alarms with predetermined physical locations.

118. Apparatus according to claim 113 arranged to access a geographically arranged database, thereby to associate service criteria with predetermined physical locations.

119. Apparatus according to claim 113, arranged to access a geographically arranged database, thereby to associate alarms and service criteria with predetermined physical locations.

120. Apparatus according to claim 115, wherein said service criteria comprise criteria to conform with location-based legal restrictions.

121. Apparatus according to claim 115, wherein said service criteria comprise criteria to conform to location-based contractual restrictions.

122. Apparatus according to clam 115, wherein said service criteria comprise criteria to conform to location-based commercial restrictions.

123. Apparatus according to claim 1114, further comprising a service level controller for selecting service criteria to be provided to said user client based on sad topological location.

124. Apparatus according to claim 114, further comprising a routing controller for controlling routing to said user client based on said topological location.

125. Apparatus for determining a location of a user client in an electronic interaction with a server over a network having a plurality of nodes at different locations the apparatus comprising:
a network node data gatherer comprising a request for a user telephone number,
a network node data correlator for correlating said user telephone number with a physical map of said telephone network, said map being usable to correlate a physical location to a telephone number network node location map, thereby to provide said server with a location for said user client, and
a digital media distributor associated with said network data correlator and operable to use said location to govern digital media distribution to said user client, said apparatus further comprising an authentication unit being operable to confirm contact via said telephone number by giving a user an identification for looping around said network and said user client and a connection made using said telephone number.

126. Apparatus according to claim 125, said authentication unit being operable to obtain a modem telephone number of said user client, thereby to attempt to establish contact with said user client.

127. Apparatus according to claim 125, said authentication unit being operable to obtain a modem telephone number of said user client and to determine that contact is established with said user client using said given modem number.

128. Apparatus according to claim 127, said authentication unit being operable to send authentication information via said direct connection for return via said network connection.

129. Apparatus according to claim 127, said authentication unit being operable to send authentication via said network for return via said direct connection.

130. Apparatus according to claim 125, further comprising a line measuring unit for measuring connection line qualities, thereby to obtain confirmation of said location.

131. Apparatus according to claim 130, said line measuring unit comprising a connection comparison unit for comparing line qualities of different connections.

132. Apparatus according to claim 130, wherein said qualities include any ones of a group comprising; signal to noise ratio, specific frequency attenuation, end path delay, echo characteristics, delay variance, and compression artifacts.

133. Apparatus according to claim 125, comprising an interface for interfacing to a telephone number resolving system, thereby to obtain service level conditions associated with particular telephone numbers.

134. Apparatus according to claim 125, said network node data gatherer comprising a request for the user to contact a telephone number, said apparatus being operable to confirm contact via said telephone number by giving a user an identification for looping back to said apparatus using said user client and a connection made using said telephone number.

135. Apparatus according to claim 125, further comprising an authentication unit contactable by the modem of said user client thereby to attempt to establish contact with said user client.

136. Apparatus according to claim 135, said authentication unit being operable to send authentication information via said connection for return via sad network connection.

137. Apparatus according to claim 135, said authentication unit being operable to send authentication via said network for return via said direct connection.

138. Apparatus for determining a location of a user client in an electronic interaction with a server over a network having a plurality of nodes at different locations, the apparatus comprising:
a network node data gatherer for obtaining from the vicinity of said user client network node information,
a network node data correlator for correlating said network node information with a network node location nap, thereby to provide said server with a location for said user client,
trace routing functionality for determining a network node distance and route of a user client by sending and attempting to receive response messages having varied time to live values,
and a second correlator for correlating between said determined location and said determined network node distance and route.

139. Apparatus according to claim 138, said second correlator being further operable to correlate using additional nodes to improve result accuracy.

140. Apparatus for determining a location of a user client in an electronic interaction with a server over a network having a plurality of nodes at different locations, the apparatus comprising:
a network node data gatherer for obtaining from the vicinity of said user client network node information, and
a network node data correlator for correlating said network node information with a network node location map, thereby to provide said server with a location for said user client,
and wherein said network node data gatherer is a software agent for placing at least one of said plurality of nodes.

141. Apparatus according to claim 140 wherein said network access node comprises a digital network access node.

142. Apparatus according to claim 141, wherein said digital network access node comprises a digital line access multiplexer.
